(19) United States
(12) Patent Application Publication
(10) Pub. No.: US 2023/0230392 A1
(43) Pub. Date: Jul. 20, 2023

(54) CAMERA EXTRINSIC PARAMETER CORRECTION METHOD AND APPARATUS, AND STORAGE MEDIUM

(71) Applicant: BEIJING BAIDU NETCOM SCIENCE TECHNOLOGY CO., LTD., Beijing (CN)

(72) Inventors: Feng TIAN, Beijing (CN); Daochen CHONG, Beijing (CN); Yuting LIU, Beijing (CN)

(73) Assignee: BEIJING BAIDU NETCOM SCIENCE TECHNOLOGY CO., LTD., Beijing (CN)

(21) Appl. No.: 18/054,773

(22) Filed: Nov. 11, 2022

(30) Foreign Application Priority Data
Jan. 17, 2022 (CN) 202210049105.0

(51) Int. Cl. G06V 20/56; G06T 7/80

(52) U.S. Cl. CPC G06V 20/588; G06T 7/80

(57) ABSTRACT

A camera extrinsic parameter correction method includes acquiring multiple road surface images continuous in time and performing classification to obtain a mutated image and a time-adjacent image corresponding to the mutated image; determining a matching point pair from pixel points of the mutated image and pixel points of the corresponding time-adjacent image and determining a target view angle point pair of the matching point pair in a target view angle; and correcting a camera extrinsic parameter corresponding to the mutated image according to the difference between two target view angle points in the target view angle point pair, where the camera extrinsic parameter is configured for conversion of a pixel point in a current view angle into a pixel point in the target view angle.

### CROSS-REFERENCE TO RELATED APPLICATION

This application claims priority to Chinese Patent Application No. 202210049105.0, filed on Jan. 17, 2022, the disclosure of which is incorporated herein by reference in its entirety.

### TECHNICAL FIELD

The present disclosure relates to the field of image processing, particularly the field of self-driving and intelligent transportation, for example, a camera extrinsic parameter correction method and apparatus, an electronic device, and a storage medium.

### BACKGROUND

In image measurement processes and machine vision applications, to determine the relationship between the three-dimensional geometrical position of a point on the surface of a spatial object and the corresponding point in an image, a geometric model of camera imaging must be established. Geometric model parameters of the model are camera parameters.

Camera calibration is critical in the process of recovering three-dimensional information of an object in a two-dimensional image. There is a correspondence between a spatial point in a geometric imaging model and an image point in an image plane of a camera. The correspondence is determined by camera parameters (including camera intrinsic parameters and extrinsic parameters).

### SUMMARY

The present disclosure provides a camera extrinsic parameter correction method and apparatus, an electronic device, and a storage medium.

According to an aspect of the present disclosure, a camera extrinsic parameter correction method is provided. The method includes acquiring multiple road surface images continuous in time and performing classification to obtain a mutated image and a time-adjacent image corresponding to the mutated image; determining a matching point pair from pixel points of the mutated image and pixel points of the corresponding time-adjacent image and determining a target view angle point pair of the matching point pair in a target view angle; and correcting a camera extrinsic parameter corresponding to the mutated image according to the difference between two target view angle points in the target view angle point pair, where the camera extrinsic parameter is configured for conversion of a pixel point in the current view angle into a pixel point in the target view angle.

According to another aspect of the present disclosure, a camera extrinsic parameter correction apparatus is provided. The apparatus includes an image classification module configured to acquire a plurality of road surface images continuous in time and perform classification to obtain a mutated image and a time-adjacent image corresponding to the mutated image; a point pair acquisition module configured to determine a matching point pair from pixel points of the mutated image and pixel points of the corresponding time-adjacent image and determine a target view angle point pair of the matching point pair in a target view angle; and an extrinsic parameter correction module configured to correct a camera extrinsic parameter corresponding to the mutated image according to the difference between two target view angle points in the target view angle point pair, where the camera extrinsic parameter is configured for conversion of a pixel point in the current view angle into a pixel point in the target view angle.

According to another aspect of the present disclosure, an electronic device is provided. The electronic device includes at least one processor and a memory communicatively connected to the at least one processor.

The memory stores instructions executable by the at least one processor to enable the at least one processor to perform the camera extrinsic parameter correction method according to any embodiment of the present disclosure.

According to another aspect of the present disclosure, a non-transitory computer-readable storage medium is provided. The storage medium stores computer instructions configured to cause a computer to perform the camera extrinsic parameter correction method according to any embodiment of the present disclosure.

According to another aspect of the present disclosure, a computer program product is provided. The computer program product includes a computer program which, when executed by a processor, causes the processor to perform the camera extrinsic parameter correction method according to any embodiment of the present disclosure.

According to embodiments of the present disclosure, the accuracy of the camera extrinsic parameter can be improved, and thereby the accuracy of image conversion can be improved.

It is to be understood that the content described in this part is neither intended to identify key or important features of embodiments of the present disclosure nor intended to limit the scope of the present disclosure. Other features of the present disclosure are apparent from the description provided hereinafter.

### BRIEF DESCRIPTION OF DRAWINGS

The drawings are intended to provide a better understanding of the solution and not to limit the present disclosure.

FIG. 1 is a flowchart of a camera extrinsic parameter correction method according to an embodiment of the present disclosure.

FIG. 2 is a flowchart of a camera extrinsic parameter correction method according to an embodiment of the present disclosure.

FIG. 3 is a flowchart of a camera extrinsic parameter correction method according to an embodiment of the present disclosure.

FIG. 4 is a flowchart of a camera extrinsic parameter correction method according to an embodiment of the present disclosure.

FIG. 5 is a diagram of lane width errors according to an embodiment of the present disclosure.

FIG. 6 is a scene flowchart of a camera extrinsic parameter correction method according to an embodiment of the present disclosure.

FIG. 7 is a diagram of a camera extrinsic parameter correction apparatus according to an embodiment of the present disclosure.

FIG. 8 is a block diagram of an electronic device for performing a camera extrinsic parameter correction method according to an embodiment of the present disclosure.

### DETAILED DESCRIPTION

Example embodiments of the present disclosure, including details of embodiments of the present disclosure, are described hereinafter in conjunction with drawings to facilitate understanding. The example embodiments are illustrative. Therefore, it is to be appreciated by those of ordinary skill in the art that various modifications and changes may be made to the embodiments described herein without departing from the scope and spirit of the present disclosure. Similarly, description of well-known functions and constructions is omitted hereinafter for clarity and conciseness.

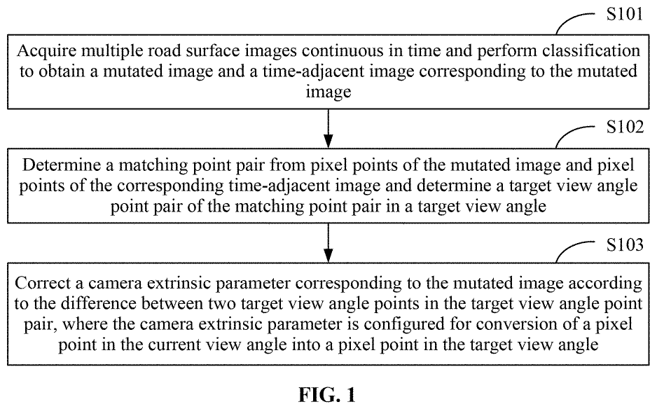

FIG. 1 is a flowchart of a camera extrinsic parameter correction method according to an embodiment of the present disclosure. This embodiment is applicable to the case of correction of a vehicle-mounted-camera extrinsic parameter for conversion between the current view angle and the target view angle. The method according to this embodiment may be performed by a camera extrinsic parameter correction apparatus. The apparatus may be implemented as software and/or hardware and is configured in an electronic device having a certain data operation capability. The electronic device may be a client device or a server device. The client device is, for example, a mobile phone, a tablet computer, a vehicle-mounted terminal, or a desktop computer.

In S101, multiple road surface images continuous in time are acquired, and classification is performed so that a mutated image and a time-adjacent image corresponding to the mutated image are obtained.

The multiple road surface images continuous in time refer to multiple images continuously collected from a road surface from a front view angle. For example, a device for collecting a road surface image includes a vehicle-mounted camera. A vehicle-mounted camera on a running vehicle collects images from a road surface the vehicle runs through and determines multiple road surface images continuous in time. The vehicle-mounted camera may be placed at the front of the vehicle, for example, the head of the vehicle, to collect an image of the road surface in front of the vehicle along the running direction of the vehicle. Alternatively, the vehicle-mounted camera may be placed at the rear of the vehicle, for example, the back of the vehicle, to collect an image of the road surface behind the vehicle along the direction opposite to the running direction of the vehicle.

The mutated image may refer to an image captured by the camera in a non-standard pose and be used for the correction of a camera extrinsic parameter corresponding to the mutated image. The time-adjacent image corresponding to the mutated image serves as the reference image or the standard image of the mutated image in correction of the camera extrinsic parameter corresponding to the mutated image. For example, the time-adjacent image may refer to an image captured by the camera in a standard pose at a time adjacent to the collection time of the mutated image. The standard pose is the initial pose of the camera. The non-standard pose is a different pose from the initial pose of the camera.

In fact, when the vehicle is running on an even road, the pose of the camera is stable and can be defined as the standard pose or the initial pose. Later, when the vehicle is bumping on a slope or an uneven road, the instantaneous pose of the camera is abruptly different from the standard pose and can be defined as the non-standard pose. Accordingly, since the mutated image is an image captured by the camera in the non-standard pose, the target image obtained by performing view angle conversion on the mutated image using the camera extrinsic parameter in the standard pose is inaccurate. Thus, camera extrinsic parameter correction is adjustment of the camera extrinsic parameter in the standard pose to the camera extrinsic parameter in the non-standard pose to make the camera extrinsic parameter adapt to the pose in which the camera collects the mutated image. Conversion between images in different view angles is thus performed accurately. Therefore, with regard to a road surface image of a non-mutated image, the conversion between images in different view angles is performed by using a camera extrinsic parameter in a standard pose; and with regard to a mutated image, conversion between images in different view angles is performed by using a corresponding corrected camera extrinsic parameter so that conversion between images in different view angles is performed by using different adaptive camera extrinsic parameter with regard to different camera poses.

In S102, a matching point pair is determined from pixel points of the mutated image and pixel points of the corresponding time-adjacent image, and a target view angle point pair of the matching point pair in a target view angle is determined.

The matching point pair includes two pixels. One of the two pixels is a pixel point included in the mutated image. The other of the two pixels is a pixel point included in the time-adjacent image. The two pixel points represent coordinate points of the same object. The camera is moving when capturing images. Accordingly, a point on an object is mapped to different pixel points of different time-adjacent road surface images. A pixel point of the mutated image and a pixel point of the time-adjacent image that are mapped to the same point may form a matching point pair. In an example, object recognition is performed in the mutated image and the corresponding time-adjacent image so that the same object is determined, and a pixel point of the mutated image and a pixel point of the time-adjacent image that are mapped to the same point on the same object are determined as a matching point pair.

In this embodiment of the present disclosure, the view angle in which the camera for collecting an image captures the road surface is the current view angle. The target view angle may be different from the current view angle. In an example, in this embodiment of the present disclosure, the camera for collecting an image is a vehicle-mounted camera that captures an image along the running direction of the vehicle or along the direction opposite to the running direction of the vehicle; accordingly, the corresponding current view angle is the front view angle. The target view angle is the view angle in which a camera on an unmanned aerial vehicle captures an image from above. The matching point pair is a pixel point pair in the front view angle. The target view angle point pair is a point pair in the target view angle converted from the matching point pair. The camera extrinsic parameter is configured for conversion of a pixel point in the current view angle into a pixel point in the target view angle. In an example, corresponding vector coordinates in the world coordinate system may be determined based on a pixel point of the time-adjacent image, and the vector coordinates are then converted into a target view angle point; a pixel point of the mutated image is converted into a target view angle point through the camera extrinsic parameter in the standard pose; and the two target view angle points form the target view angle point pair. The vector coordinates mapped from the pixel point of the mutated image are the same as the vector coordinates mapped from the time-adjacent image, which represents the same point on the same object.

In S103, a camera extrinsic parameter corresponding to the mutated image is corrected according to the difference between two target view angle points in the target view angle point pair, where the camera extrinsic parameter is configured for conversion of a pixel point in the current view angle into a pixel point in the target view angle.

The difference between the two target view angle points is configured for correcting the camera extrinsic parameter corresponding to the mutated image. The two target view angle points in the target view angle should be the same. However, the pose of the camera is changed when the camera captures the mutated image, but target view angle conversion is performed on the mutated image still by using the camera extrinsic parameter in the standard pose. As a result, the target view angle point obtained by such conversion is different from the target view angle point obtained by target view angle conversion of the corresponding time-adjacent image by using the camera extrinsic parameter in the standard pose. Whereas, the two target view angle points should represent the same point. That is, the two target view angle points should be the same. Thus, it is feasible to adjust the camera extrinsic parameter corresponding to the mutated image to minimize the difference between the two target view angle points and to accurately convert the mutated image into an image in the target view angle based on the corrected camera extrinsic parameter.

There may be multiple mutated images. For each mutated image, there may be multiple time-adjacent images. With regard to one mutated image and one corresponding time-adjacent image, at least one matching point pair and at least one corresponding target view angle point pair may be determined. If there are multiple time-adjacent images, multiple target view angle point pairs may be determined. The camera extrinsic parameter is corrected such that the sum of differences between two target view angle points in multiple target view angle point pairs is minimized.

The corrected camera extrinsic parameter makes it possible to convert each road surface image into an accurate image in the target view angle and convert each road surface image into a vector image in the world coordinate system, thereby making it possible to construct a satellite image, draw a continuous lane line in the image, and reconstruct a sheltered intersection (for example, an intersection under an overpass) to form a panoramic image.

In the related art, the pose of the camera may be obtained through a device such as an inertial measurement unit (IMU) or a wheel speedometer, and thus the camera extrinsic parameter can be corrected. However, the preceding device is expensive and cannot be popularized on a large scale. Especially, the popularization of crowdsourcing visual collection scheme causes high implementation costs. Moreover, the drift problem of an IMU and the slip problem of a wheel speedometer may also affect the instantaneous pose of the camera, leading to inaccurate detection of the instantaneous pose and inaccurate correction of the camera extrinsic parameter.

According to the solution of the present disclosure, multiple road surface images continuous in time are acquired, and selection is performed so that a mutated image and a time-adjacent image corresponding to the mutated image are obtained; a matching point pair is selected from the images and converted into a target view angle point pair in a target view angle; and a camera extrinsic parameter corresponding to the mutated image is adjusted according to the difference between two target view angle points in the target view angle point pair. The camera extrinsic parameter can be corrected by software so that the hardware cost in correction of the camera extrinsic parameter can be reduced, error problems in correction by hardware can be reduced, and the correction accuracy can be improved.

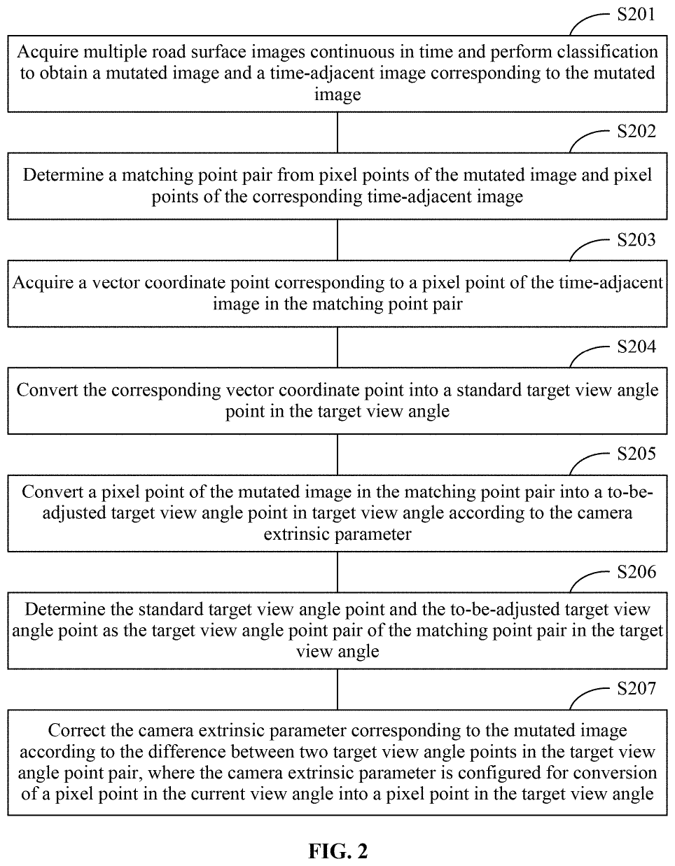

FIG. 2 is a flowchart of another camera extrinsic parameter correction method according to an embodiment of the present disclosure. This embodiment is an optimization and extension of the preceding solution and is combinable with the preceding implementations. Determining the target view angle point pair of the matching point pair in the target view angle includes acquiring a vector coordinate point corresponding to a pixel point of the time-adjacent image in the matching point pair; converting the corresponding vector coordinate point into a standard target view angle point in the target view angle; converting a pixel point of the mutated image in the matching point pair into a to-be-adjusted target view angle point in target view angle according to the camera extrinsic parameter; and determining the standard target view angle point and the to-be-adjusted target view angle point as the target view angle point pair of the matching point pair in the target view angle.

In S201, multiple road surface images continuous in time are acquired, and classification is performed so that a mutated image and a time-adjacent image corresponding to the mutated image are obtained.

Optionally, the camera extrinsic parameter correction method also includes converting a pixel point of a road surface image into a target view angle point in the target view angle according to an initial camera extrinsic parameter; acquiring a collection position corresponding to the road surface image; and converting the target view angle point into a vector coordinate point according to the collection position and determining the converted vector coordinate point as a vector coordinate point corresponding to the pixel point of the road surface image.

The initial camera extrinsic parameter is configured for conversion of a pixel point in the current view angle into a pixel point in the target view angle. The initial camera extrinsic parameter may refer to a camera extrinsic parameter of a camera which is stable in pose and is configured for collection from a preset flat road surface. Camera extrinsic parameter correction is actually correction of the initial camera extrinsic parameter to determine the instantaneous camera extrinsic parameter of a camera whose pose has changed due to a non-flat road surface. The collection position may refer to information about a geographic position where a camera collects a corresponding road surface image. The pixel point of the road surface image and the target view angle point in the target view angle may be two-dimensional points. The vector coordinate point may be a three-dimensional point. A two-dimensional point may be converted into a three-dimensional point according to the collection position. That is, the target view angle point in the target view angle may be converted into the vector coordinate point.

The collection position of an image may be acquired in the following manner: A positioning device may be mounted on a device provided with the camera. The positioning device may be used to position the camera at the time when the camera collects the image.

In fact, the collection period of the image may be different from the positioning period of the positioning device. Therefore, the positioning device may not perform positioning at the collection time of the image. That is, some images may have no collection position. Interpolation may be performed on the continuous positioning information according to the image collection time at which the camera collects an image from the road surface. For example, in the case of a vehicle-mounted camera, continuous positioning information of the vehicle may be acquired when the vehicle is running. The continuous positioning information constitutes positioning information and positioning time of each point in the running track. Interpolation may be performed on the running track according to the positioning time and the image collection time to obtain the point corresponding to the image collection time and the positioning information corresponding to the point. The positioning information corresponding to the point is determined as the positioning information of the image corresponding to the image collection time.

In an example, a pixel in the current view angle may be converted into a pixel in the target view angle according to the camera extrinsic parameter by using the formula below.

$${I}_{b v} ( u , v ) = {H}^{*} {I}_{f v} ( u , v ) , \\ H = [ \begin{matrix}{h}_{00} & {h}_{01} & {h}_{02} \\ {h}_{10} & {h}_{11} & {h}_{12} \\ {h}_{20} & {h}_{21} & 1\end{matrix} ]$$

(u, v) in I_{fv} (u, v) denotes a pixel point (coordinates) in the image in the current view angle. (u, v) in I_{bv} (u, v) denotes a pixel point (coordinates) at the same position of the image in the target view angle. In an example, the target view angle is a top view. Correspondingly, an image in the target view angle is an aerial view.

The geographic position information of the camera collecting images may be acquired. The geographic position information corresponding to each road surface image may be thus determined. According to the geographic position information corresponding to an image, the image in the target view angle may be converted into a vector image, that is, a pixel point in the target view angle may be converted into a vector coordinate point. In an example, a pixel point in the target view angle may be converted into a vector coordinate point by using the formula below.

$${I}_{b w} ( {u}_{bw} , {v}_{b w} ) = {[ \begin{matrix}cos ( {θ}_{h} ) & ‐ sin ( {θ}_{h} ) & {x}_{E} \\ sin ( {θ}_{h} ) & cos ( {θ}_{h} ) & {y}_{N} \\ 0 & 0 & 1\end{matrix} ] [ \begin{matrix}{s}^{*} ( {u}_{b v} - {u}_{0} ) \\ {s}^{*} ( {v}_{01} - {v}_{b v} ) \\ 1\end{matrix} ]}_{[ 1 : 2 ]}$$

The geographic position information includes (Universal Transverse Mercator (UTM) grid system coordinates (x_{E}, y_{N}), heading angle θₕ). s denotes the scale ratio of the world coordinate system in the target view angle to the image coordinate system in the target view angle. (u_{bv}, v_{bv}) denotes a pixel point (coordinates) of the image in the target view angle. (u_{bw}, v_{bw}) denotes the vector coordinate point at the position corresponding to (u_{bv}, v_{bv}) in a vector image. (u₀, v₀) denotes a pixel point (coordinates) of the camera positioning device in the image in the target view angle. The positioning device may be a Global Positioning System (GPS) device.

Positioning information is acquired, and a target view angle point in the target view angle is converted into a vector coordinate point so that a coordinate point located in the reality and corresponding to a pixel point of each road surface image is determined. In this manner, a target view angle point determined by an inaccurate camera extrinsic parameter is acquired, the target view angle point determined by the inaccurate camera extrinsic parameter and an accurate target view angle point provide data support for camera extrinsic parameter correction to improve the accuracy of the camera extrinsic parameter.

In S202, a matching point pair is determined from pixel points of the mutated image and pixel points of the corresponding time-adjacent image.

Optionally, determining the matching point pair from the pixel points of the mutated image and the pixel points of the corresponding time-adjacent image includes determining a to-be-adjusted pixel point from the pixel points of the mutated image and a standard pixel point from the pixel points of the corresponding time-adjacent image according to the motion state of the pixel points of the mutated image, the motion state of the pixel points of the corresponding time-adjacent image, and the collection time length between the mutated image and the corresponding time-adjacent image, where the to-be-adjusted pixel point and the standard pixel point correspond to the same vector coordinate point; and determining the to-be-adjusted pixel point and the standard pixel point as the matching point pair.

The motion state of a pixel point may refer to the motion direction and the motion speed of a vector coordinate point in the reality at the current collection time, where the vector coordinate point is represented by the pixel point. The collection time length between the mutated image and the time-adjacent image refers to the time length between the collection time of the mutated image and the collection time of the time-adjacent image. The to-be-adjusted pixel point is a pixel point in the mutated image. A pixel point of the time-adjacent image matches the to-be-adjusted pixel point. The standard pixel point is a pixel point of the time-adjacent image. A pixel point of the mutated image matches the standard pixel point. The motion state of a pixel point in a road surface image may be determined according to the motion state of a camera that is collecting the road surface image. In an example, the camera is a vehicle-mounted camera. The motion state of a pixel point in a road surface image may refer to the motion state of a vehicle when the camera is collecting the road surface image, where the vehicle is provided with the camera. The collection time length may be determined according to the collection time at which the camera collects an image.

In an example, the position to which a pixel point of the mutated image is mapped to in the time-adjacent image may be determined according to the motion state of the pixel point of the mutated image and the collection time length between the mutated image and the time-adjacent image later than the mutated image. If this position is outside the range of the time-adjacent image, the pixel point is discarded. If this position is within the range of the time-adjacent image, the pixel point is determined as the to-be-adjusted pixel point, and the pixel point at this position of the time-adjacent image is determined as the standard pixel point of the to-be-adjusted pixel point.

In another example, the position to which a pixel point of the time-adjacent image earlier than the mutated image is mapped to in the mutated image may be determined according to the motion state of the pixel point of the time-adjacent image earlier than the mutated image and the collection time length between the time-adjacent image earlier than the mutated image and the mutated image. If this position is outside the mutated image, the pixel point is discarded. If this position is within the mutated image, the pixel point is determined as the standard pixel point, and the pixel point at this position of the mutated image is determined as the to-be-adjusted pixel point.

In an example, the to-be-adjusted pixel point from the pixel points of the mutated image and the standard pixel point from the pixel points of the corresponding time-adjacent image may be determined by using an optical flow method according to the motion state of the pixel points of the mutated image, the motion state of the pixel points of the corresponding time-adjacent image, and the collection time length between the mutated image and the corresponding time-adjacent image.

Additionally, the matching point pair may also be selected according to the random sample consensus (RANSAC) algorithm. The RANSAC algorithm is used for removing a noise sample from a group of samples to obtain a valid sample, for example, selecting a stable matching point pair from multiple matching point pairs. In this manner, the representativeness of the matching point pair is improved, and thereby the accuracy of camera correction is improved.

The pixel point motion track between the mutated image and the time-adjacent image may be determined according to the motion state and the collection time length of the pixel points so that the pixel point pair corresponding to the same vector coordinate point is acquired and so that the matching point pair is determined. In view that the pixel points in the matching point pair represent the same vector coordinate point in reality, the difference between the two pixel points in the matching point pair in the target view angle is reduced so as to correct the camera extrinsic parameter. In this manner, the correction accuracy of the camera extrinsic parameter is improved.

In S203, a vector coordinate point corresponding to a pixel point of the time-adjacent image in the matching point pair is acquired.

The matching point pair includes a pixel point belonging to the mutated image and a pixel point belonging to the time-adjacent image corresponding to the mutated image.

The vector coordinate point corresponding to the pixel point belonging to the time-adjacent image is obtained in the following manner: The pixel point of the time-adjacent image is converted according to the camera extrinsic parameter in the standard pose so that the corresponding target view angle point is obtained; and then vector conversion is performed so that the corresponding vector coordinate point is obtained.

In S204, the corresponding vector coordinate point is converted into a standard target view angle point in the target view angle.

The vector coordinate point may be converted according to the vector coordinate point corresponding to the pixel point and the geographic position information corresponding to the image so that the standard target view angle point is obtained. In an example, (u_{bv}, v_{bv}) may be converted into (u_{bw}, v_{bw}) by using the preceding formula, and (u_{bw}, v_{bw}) may be inversely converted into (u_{bv}, v_{bv}) by using the preceding formula. Here, a target view angle point in the target view angle and the corresponding vector coordinate point corresponding to each pixel point included in each road surface image may be calculated in advance. In this case, the target view angle point in the target view angle and the corresponding vector coordinate point are directly acquired.

The standard target view angle point is a pixel point in the target view angle and corresponding to the pixel point of the time-adjacent image.

In S205, a pixel point of the mutated image in the matching point pair is converted into a to-be-adjusted target view angle point in target view angle according to the camera extrinsic parameter.

The to-be-adjusted target view angle point is a pixel point in the target view angle and corresponding to the pixel point of the mutated image. The pixel point belonging to the mutated image may be converted according to the camera extrinsic parameter so that the to-be-adjusted target view angle point is obtained.

The camera extrinsic parameter is adjusted by using the standard target view angle point as a correct target view angle point and by using the to-be-adjusted target view angle point as an incorrect to-be-adjusted target view angle point. In this manner, the to-be-adjusted target view angle point keeps approaching the standard target view angle point so that the camera extrinsic parameter of the camera for collecting the mutated image and in the current pose is determined.

In S206, the standard target view angle point and the to-be-adjusted target view angle point are determined as the target view angle point pair of the matching point pair in the target view angle.

In S207, the camera extrinsic parameter corresponding to the mutated image is corrected according to the difference between two target view angle points in the target view angle point pair, where the camera extrinsic parameter is configured for conversion of a pixel point in the current view angle into a pixel point in the target view angle.

Optionally, the camera extrinsic parameter is of a vehicle-mounted camera.

The camera may be disposed on a vehicle so that the camera extrinsic parameter is adjusted in real time as the camera pose changes due to slopes or bumping when the vehicle is running. In this manner, the accuracy of the image in the target view angle and converted based on the camera extrinsic parameter, and timeliness of camera extrinsic parameter correction is improved.

In the solution of the present disclosure, the vector coordinate point corresponding to the pixel point belonging to the time-adjacent image is converted into the standard target view angle point in the target view angle, and the pixel point belonging to the mutated image is converted into the to-be-adjusted target view angle point in the target view angle so that the target view angle point pair is formed and so that the camera extrinsic parameter is adjusted. In this manner, the incorrect to-be-adjusted target view angle point keeps approaching a correct standard target view angle point. Thus, the consistency of the same vector coordinate point in different images is achieved, and the accuracy of camera extrinsic parameter correction is improved.

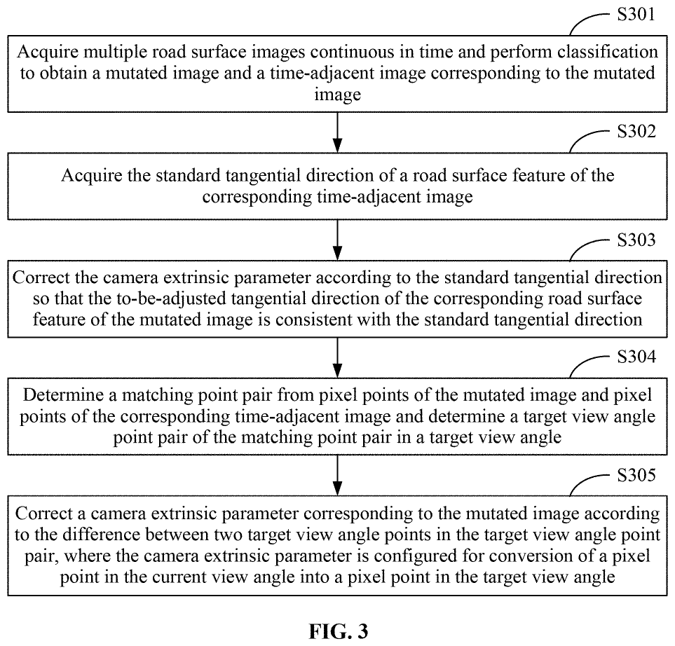

FIG. 3 is a flowchart of a camera extrinsic parameter correction method according to an embodiment of the present disclosure. This embodiment is an optimization and extension of the preceding solution and is combinable with the preceding implementations. The camera extrinsic parameter correction method is optimized in the following manner: The method also includes acquiring the standard tangential direction of a road surface feature of the corresponding time-adjacent image; and correcting the camera extrinsic parameter according to the standard tangential direction so that the to-be-adjusted tangential direction of a corresponding road surface feature of the mutated image is consistent with the standard tangential direction.

In S301, multiple road surface images continuous in time are acquired, and classification is performed so that a mutated image and a time-adjacent image corresponding to the mutated image are obtained.

In S302, the standard tangential direction of a road surface feature of the corresponding time-adjacent image is acquired.

The road surface feature may refer to a feature object that exists on a road surface and represents the road surface. The road surface feature of the time-adjacent image is used as a criterion for correcting the camera extrinsic parameter of the mutated image. The road surface feature may refer to a feature object having a certain length. For example, the road surface feature may be a traffic marking. For example, the traffic marking may include a lane line, an edge line, a guide arrow, or a stop line. The standard tangential direction is configured to indicate the direction of the road surface feature. Since the road surface feature has a certain length, the standard tangential direction may identify the direction feature of the road surface feature.

In fact, in images continuous in time, the position and length (big when near while small when far) of the same road surface feature change, but the tangential direction of the same road surface feature remains unchanged. Therefore, the camera extrinsic parameter of the mutated image may be corrected by using the tangential direction consistency of the same road surface feature in the mutated image and the time-adjacent image.

The standard tangential direction is a vector parameter. The standard tangential direction may be acquired in the following manner: The time-adjacent image is converted into an image in the target view angle according to a standard camera extrinsic parameter or an initial camera extrinsic parameter, and then the image in the target view angle is converted into a vector image in the world coordinate system, that is, a pixel point in the target view angle is converted into a vector coordinate point in the world coordinate system, so that the standard tangential direction of the vector coordinate point corresponding to the pixel point region of the road surface feature is obtained. The standard tangential direction of the vector coordinate point corresponding to the pixel point region of the road surface feature may be acquired in the following manner: Multiple boundary pixel points of the same boundary line are acquired and then fitted into a straight line so that the tangential direction of the straight line is obtained; and the tangential direction of the straight line is determined as the standard tangential direction.

In S303, the camera extrinsic parameter is corrected according to the standard tangential direction so that the to-be-adjusted tangential direction of the corresponding road surface feature of the mutated image is consistent with the standard tangential direction.

The corresponding road surface feature is the same as the road surface feature of the time-adjacent image. The to-be-adjusted tangential direction of the corresponding road surface feature may refer to the tangential direction of the road surface feature that is in the mutated image and is the same as the road surface feature of the time-adjacent image. In this embodiment of the present disclosure, the moving direction of the camera in the collection process of road surface images continuous in time is fixed. Correspondingly, the moving direction of the pixel point in the mutated image is consistent with the moving direction of the pixel point in the corresponding time-adjacent image so that the road surface feature of the mutated image and the road surface feature of the corresponding time-adjacent image are consistent in tangential direction.

The to-be-adjusted tangential direction may be determined by using the preceding method for determining the standard tangential direction. The camera extrinsic parameter may be corrected in the following manner: The camera extrinsic parameter correction amount is acquired, the standard camera extrinsic parameter is accumulated so that a corrected camera extrinsic parameter is obtained, and a new to-be-adjusted tangential direction is calculated based on the corrected camera extrinsic parameter. Based on the difference between the new to-be-adjusted tangential direction and the standard tangential direction and the difference between the previous to-be-adjusted tangential direction and the standard tangential direction, the next camera extrinsic parameter correction amount is determined. The camera extrinsic parameter is continuously corrected so that the difference between the to-be-adjusted tangential direction and the standard tangential direction satisfies a matching condition so that it is determined that the to-be-adjusted tangential direction is consistent with the standard tangential direction. In an example, the difference may satisfy the matching condition in the following manner: The angle difference value included in the difference is less than or equal to a preset angle threshold.

In S304, a matching point pair is determined from pixel points of the mutated image and pixel points of the corresponding time-adjacent image, and a target view angle point pair of the matching point pair in a target view angle is determined.

In S305, a camera extrinsic parameter corresponding to the mutated image is corrected according to the difference between two target view angle points in the target view angle point pair, where the camera extrinsic parameter is configured for conversion of a pixel point in the current view angle into a pixel point in the target view angle.

The sequence of S302-S303 and S304-S305 may be adjusted. The sequence of the two steps for correcting the camera extrinsic parameters may be adjusted.

Additionally, the camera extrinsic parameter used for the road surface images continuous in time may be a standard camera extrinsic parameter so that the camera extrinsic parameter of each mutated image is adjusted from the standard camera extrinsic parameter. Alternatively, the camera extrinsic parameter used for the road surface images continuous in time may be the camera extrinsic parameter of the road surface image collected at the previous adjacent time so that the camera extrinsic parameter of each mutated image may not be adjusted from the standard camera extrinsic parameter and may be a camera extrinsic parameter corrected from the road surface image collected at the previous adjacent time. The camera extrinsic parameter used for the road surface images continuous in time may be set according to the requirements and is not limited herein.

Optionally, correcting the camera extrinsic parameter corresponding to the mutated image according to the difference between the two target view angle points in the target view angle point pair includes continuing correcting the corrected camera extrinsic parameter according to the difference between the two target view angle points in the target view angle point pair.

After the camera extrinsic parameter is corrected according to the standard tangential direction, the corrected camera extrinsic parameter continues being corrected according to the target view angle point. In fact, correction according to the tangential direction is angle-level correction while correction according to the target view angle point is pixel-level correction. That is, correction according to the target view angle point pair is coarser in granularity than correction according to the tangential direction.

The camera extrinsic parameter is first coarsely corrected according to the standard tangential direction and then finely corrected according to the target view angle point pair. In this manner, the range of fine correction is reduced, and the efficiency of fine correction is improved. Moreover, the two-step correction enables a higher correction accuracy.

According to the solution of the present disclosure, the camera extrinsic parameter is further corrected according to the consistency between the tangential direction of the road surface feature of the time-adjacent image and the tangential direction of the road surface feature of the mutated image. In this manner, the camera extrinsic parameter is corrected in a different dimension, the corrected content of the camera extrinsic parameter is increased, and the accuracy of the corrected camera extrinsic parameter is improved.

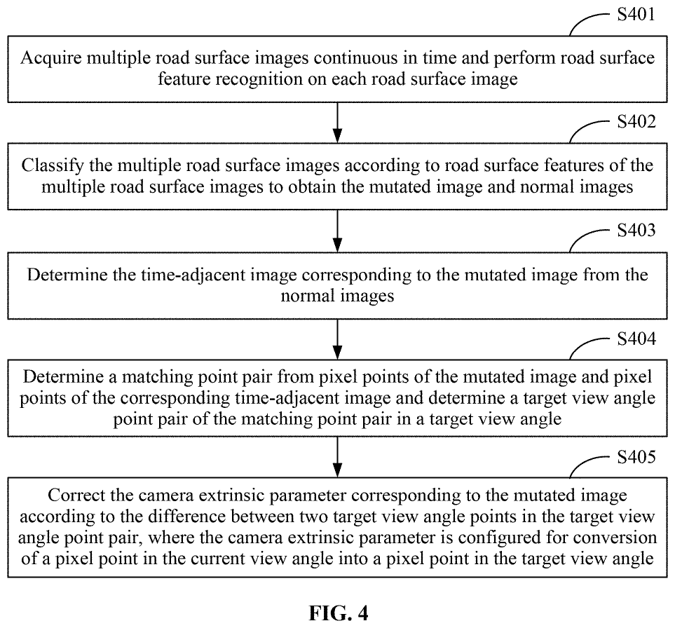

FIG. 4 is a flowchart of a camera extrinsic parameter correction method according to an embodiment of the present disclosure. This embodiment is an optimization and extension of the preceding solution and is combinable with the preceding implementations. Performing the classification to obtain the mutated image and the time-adjacent image corresponding to the mutated image includes performing road surface feature recognition on the multiple road surface images; classifying the multiple road surface images according to road surface features of the multiple road surface images to obtain the mutated image and normal images; and determining the time-adjacent image corresponding to the mutated image from the normal images.

In S401, multiple road surface images continuous in time are acquired, and road surface feature recognition is performed on each road surface image.

Initial images obtained by collection of images continuous in time by the camera from the road surface are acquired. The initial images are converted into road surface images according to the precalibrated camera intrinsic parameter. In an example, the camera intrinsic parameter may be calibrated by using the Zhang Zhengyou checkerboard method. The camera intrinsic parameter is used for removing the distortion from an image, thereby improving the image quality and reducing the image distortion.

Road surface feature recognition is used for recognition of the road surface feature of a road surface image. In an example, a semantic segmentation algorithm may be used to recognize the road surface feature region of the road surface image. For example, DeepLabv3+ may be used for semantic segmentation. Additionally, the road surface feature of the road surface image may be refined in the following manner: The semantic segmentation image is binarized, the skeleton extraction is performed on the binarized semantic segmentation image, and the connective region of the semantic segmentation image subjected to the skeleton extraction is refined into a pixel width for representing a corresponding road surface feature such as traffic marking semantic information.

In S402, the multiple road surface images are classified according to road surface features of the multiple road surface images so that the mutated image and normal images are obtained.

The mutated image may refer to an image collected when the camera pose changes. The mutated image is used for determining a difference caused by a mismatch between the camera pose and the camera extrinsic parameter so as to correct the camera extrinsic parameter according to the difference. A normal image is an image collected by the camera when the camera pose is stable and matches the standard camera extrinsic parameter.

Usually, the road surface images continuous in time include the region of the same road surface feature, and data of a same road surface feature mapped to the real road plane (that is, the world coordinate system) should be the same. Data of the road surface feature of the mutated image mapped to the real road plane is different from data of the road surface feature of an image collected at an earlier time and/or an image collected at a later time mapped to the real road plane. Data of the road surface feature mapped to the real road plane is different in the following manner: Data of the road surface feature of the mutated image mapped to the real road plane includes curved (lane line) data, skewed (guide arrow) data, or non-parallel (edge line) data. In fact, when the camera pose is stable and the camera extrinsic parameter remains unchanged, data of the road surface features of the multiple continuous road surface images mapped to the real road plane is coherent and has no mutation. However, due to the change of the camera pose during the capturing process, the camera extrinsic parameter changes. As a result, data of the road surface feature of a mutated image mapped to the real road plane is inconsistent with data of the road surface feature of a normal image mapped to the real road plane. In this manner, according to the inconsistency of data of the multiple continuous road surface images mapped to the real road plane, a mutated image having a mutated road surface feature and a normal image having no mutated road surface feature are selected.

In an example, it is feasible to convert a road surface image with a recognized road surface feature into an image in the target view angle according to the standard camera extrinsic parameter and convert the image in the target view angle into a vector image according to the collection position of each road surface image. In this manner, information about each road surface feature in the world coordinate system can be determined. According to information about each road surface feature in the world coordinate system, an image with information mutation among the road surface images continuous in time is determined as a mutated image, and an image with stable information among the road surface images continuous in time is determined as a normal image.

Classifying the multiple road surface images according to the road surface features of the multiple road surface images to obtain the mutated image and the normal images includes determining, according to the road surface features of the plurality of road surface images, target attribute values of the road surface features; determining the average attribute value of the road surface features of the multiple road surface images according to the timing of the multiple road surface images and the target attribute values of the road surface features of the multiple road surface images; and classifying the multiple road surface images according to the identifier attribute threshold and the difference between each of the target attribute values of the road surface features of the multiple road surface images and the average attribute value of the road surface features of the multiple road surface images to obtain the mutated image and the normal images.

The timing of the road surface images refers to the collection time sequence of the road surface images. A target attribute value is configured to quantify feature information of the road surface feature. The target attribute value may refer to the target attribute value of the road surface feature of a road surface image. The average attribute value refers to the average value of the target attribute values of the multiple road surface features continuous in time. The average attribute value is configured to measure whether the target attribute value mutates so as to select a mutated image and a normal image.

The timing of each road surface image is used for acquisition of the multiple road surface images continuous in time. The multiple road surface images continuous in time are determined as the image range for calculation of the average attribute value. In an example, one road surface image may be selected from the road surface images and determined as the current road surface image. The N consecutive road surface images earlier than the current road surface image, the N consecutive road surface images later than the current road surface image, and the current road surface image, that is, 2N+1 road surface images (1 indicates the current road surface image), are determined as the image range for calculation of the average attribute value of the current road surface image. Additionally, if the number of road surface images earlier than the current road surface image or road surface images later than the current road surface image is less than N, less than 2N+1 images may be acquired; or more images are acquired from another side such that 2N consecutive road surface images adjacent to the current road surface image, that is, a total of 2N+1 road surface images, are acquired.

The timing of road surface images having the same road surface feature may be acquired so that multiple road surface features continuous in time are determined. Then the average attribute value is calculated according to the target attribute values of these road surface features. The identifier attribute threshold is determined and used for selection of a mutated image and a normal image. Classifying the road surface images according to the identifier attribute threshold and the difference between the target attribute value and the average attribute value to obtain a mutated image and a normal image includes that a road surface image corresponding to such a target attribute value that the difference between the target attribute value and the average attribute value is greater than or equal to the identifier attribute threshold is determined as a mutated image, and a road surface image corresponding to such a target attribute value that the difference between the target attribute value and the average attribute value is less than the identifier attribute threshold is determined as a normal image.

The target attribute values of the road surface features may include at least one type of target attribute value of at least one type of road surface feature. Determination may be performed with regard to each type of target attribute value of each type of road surface feature. When the difference between at least one target attribute value and the corresponding average attribute value is greater than or equal to the corresponding identifier attribute threshold, the road surface image corresponding to the at least one target attribute value is determined as a mutated image. Alternatively, when the difference between at least one target attribute value and the corresponding average attribute value is less than the corresponding identifier attribute threshold, the road surface image corresponding to the at least one target attribute value is determined as a normal image. For example, the target attribute value may include the lane width between two lane lines, the road width between edge lines, or the amount of width variation between guide arrows.

In an example, the at least one type of road surface feature includes lane lines, the at least one type of target attribute value includes a lane width error of the lane lines, and the average attribute value is the average lane width error of 2N+1 road surface images continuous in time. The lane width error u^{k} may be calculated by using the formula below.

$${u}^{k} = \frac{1}{{m}^{*} n} {\sum }_{i = 1}^{m} {\sum }_{{j = 1}^{}}^{n = 20} \vert {d}_{i , j}^{k} - {d}_{i , j}^{M} \vert$$

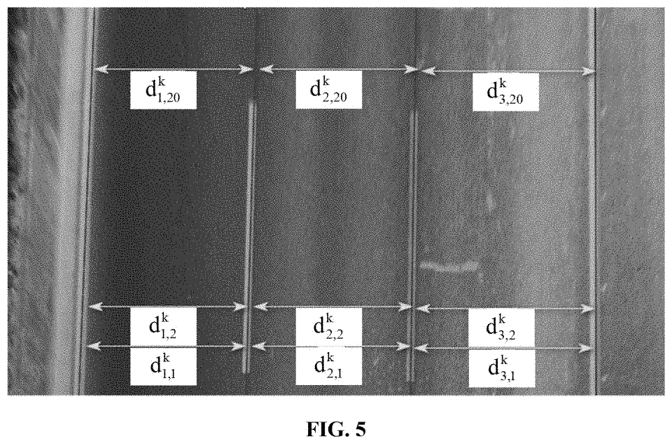

As shown in FIG. 5, in the vector image, sampling is performed at intervals of a preset distance (for example, 0.3 m) from bottom to top. d_{i,j}^{k} denotes the lane width of the sampled lane that is the ith lane from left to right and the jth lane from bottom to top in the kth frame of vector image. d_{i,j}^{M} denotes the average lane width calculated from at least one time-adjacent vector image corresponding to the kth frame of vector image. m denotes the number of lane widths. n denotes the number of times of sampling from bottom to top. In an example, the cumulative sum of the lane widths of 2N+1 sliding frames whose center is the current frame (the kth frame) is divided by 2N+1, and the quotient of this division is determined as the average lane width of the current frame (the kth frame). The 2N+1 sliding frames include N frames earlier than the kth frame, the kth frame, and N frames later than the kth frame among the images sorted in time order.

In an example, the identifier attribute threshold Th_{road}=0.3 m. Road surface images whose u^{k}>Th_{road}=0.3 m are added to set_{bad}={k₁, k₁ ∈ mᵢ, . . . , mⱼ} and determined as a mutated image set. Road surface images whose u^{k}≤Th_{road}=0.3 m are added to set_{good}={k₂, k₂ ∈ nᵢ, . . . , nⱼ} and determined as a normal image set.

The road surface images are classified according to the identifier attribute threshold and the difference between each of the target attribute values of the road surface features of the road surface images and the average attribute value of the road surface features of the road surface images. In this manner, an image whose road surface feature has a mutated attribute value can be accurately determined, and the detection accuracy of a mutated image can be improved.

In S403, the time-adjacent image corresponding to the mutated image is determined from the normal images.

Among the normal images, a normal image overlapping a region of the mutated image is determined as the time-adjacent image. For example, multiple images collected at a time earlier and/or later than the collection time of the mutated image may be determined as time-adjacent images. An image that is collected during the collection time that has a target time length is determined as the mutated image. The target time length may be determined according to the collection frequency of road surface images and the motion speed of the camera. The target time length is used for ensuring that there is an overlapping region between the time-adjacent image and the mutated image. Alternatively, a normal image overlapping a region of the mutated image may be determined as the time-adjacent image, where the size of the overlapping region may be set to be greater than or equal to a preset overlap threshold.

In S404, a matching point pair is determined from pixel points of the mutated image and pixel points of the corresponding time-adjacent image, and a target view angle point pair of the matching point pair in a target view angle is determined.

In S405, the camera extrinsic parameter corresponding to the mutated image is corrected according to the difference between two target view angle points in the target view angle point pair, where the camera extrinsic parameter is configured for conversion of a pixel point in the current view angle into a pixel point in the target view angle.

According to the solution of the present disclosure, the road surface features of the road surface images are recognized, and the mutated image and normal images are selected according to the consistency of the road surface features of the road surface images in the continuous time; at least one time-adjacent normal image is selected from the normal images and determined as the time-adjacent image; and a mutated image whose camera pose does not match the camera extrinsic parameter is selected, the camera extrinsic parameter is corrected according to the target view angle point pair in the mutated image and the time-adjacent image and according to the difference of the target view angle point pair caused by the inconsistency between the camera pose and the camera extrinsic parameter, and the camera extrinsic parameter is corrected by using the difference. In this manner, an image collected by the camera with a changed pose can be accurately selected, and the camera extrinsic parameter corresponding to the changed pose can be corrected. Thus, the camera extrinsic parameter can be corrected in real time, and the camera extrinsic parameter can be corrected in a targeted manner so that the correction accuracy of the camera extrinsic parameter can be improved.

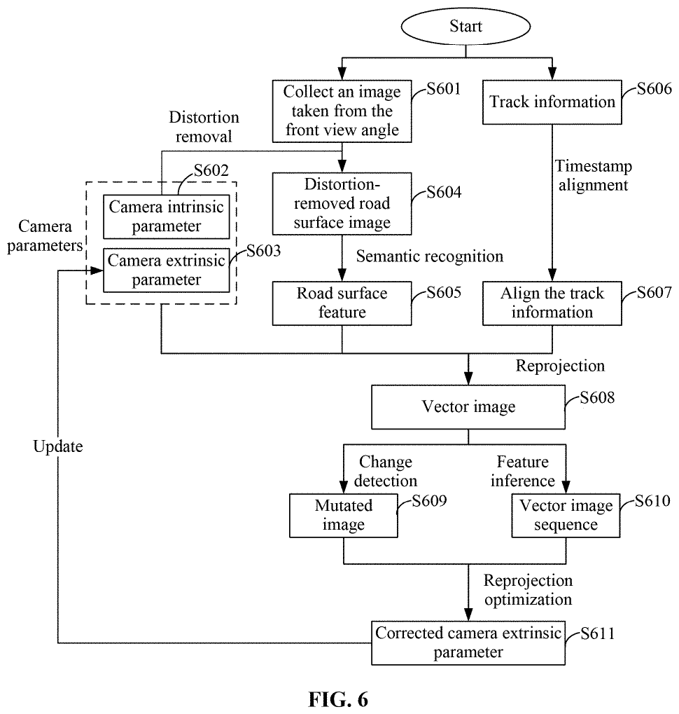

FIG. 6 is a scene flowchart of another camera extrinsic parameter correction method according to an embodiment of the present disclosure. The camera is a vehicle-mounted camera. The current view angle is a front view angle. That is, the camera collects images from a front view angle. The target view angle is a top view. An image in the target view angle is an aerial image. A vector image is a vector aerial image. The camera extrinsic parameter correction method may include the steps below.

In S601, an image taken from the front view angle is collected.

The image taken from the front view angle is an initial image collected by the camera.

In S602, a precalibrated camera intrinsic parameter is acquired.

In S603, a precalibrated standard camera extrinsic parameter is acquired.

The standard camera extrinsic parameter is an initial camera extrinsic parameter.

In S604, the image taken from the front view angle is processed by using the camera intrinsic parameter so that a distortion-removed road surface image is obtained.

In S605, semantic recognition is performed on the distortion-removed road surface image so that a road surface feature is obtained.

It is feasible to perform semantic recognition on the distortion-removed road surface image by using DeepLabv3+, binarize the semantic segmentation image, the skeleton extraction is performed on the binarized semantic segmentation image, refine the connective region of the semantic segmentation image subjected to the skeleton extraction into a pixel width for representing a corresponding road surface feature such as traffic marking semantic information.

In S606, the track information of the vehicle collecting the image taken from the front view angle is acquired.

In S607, the timestamp of the track information is aligned with the timestamp of the image taken from the front view angle so that the collection time of the image taken from the front view angle is aligned with the positioning time of the track points in the track information.

The positioning information of the track points corresponding to the image taken from the front view angle may be determined so that the positioning information corresponding to the road surface image is determined. Based on the collection time of the image taken from the front view angle, linear interpolation is performed on the track points in the track information to ensure that the positioning time of the track points is consistent with the collection time of the image taken from the front view angle.

In S608, the road surface feature of the road surface image is reprojected according to the camera extrinsic parameter and the positioning information corresponding to the road surface image so that a vector image is obtained.

The vector image is a vector traffic marking semantic map. The reprojection includes converting the image taken from the front view angle into an aerial image by using the camera extrinsic parameter and converting the aerial image into a vector aerial image according to the positioning information.

In S609, selection is performed according to the road surface feature of the vector image corresponding to each road surface image so that a mutated image is obtained.

In an example, the lane width error in the world coordinate system is determined according to the lane lines in the vector images corresponding to the road surface images; the average lane width error of the road surface features included in the world coordinate system road surface images is determined according to the timing of the world coordinate system road surface images and the lane width errors included in the world coordinate system road surface images; and the world coordinate system road surface images are classified according to each of the lane width errors included in the world coordinate system road surface images and the average lane width error and the identifier attribute threshold so that the mutated image and normal images are obtained.

In S610, a vector image sequence is obtained.

Vector images corresponding to road surface images continuous in time are acquired to form the vector image sequence. The vector images corresponding to road surface images continuous in time are sorted according to the collection time of the road surface images corresponding to the vector aerial images to form the vector image sequence. For example, Map={z|z=I_{bw}^{k}, k ∈ 1,2 . . . N}. Here N denotes the number of frames of the road surface images or the total number of road surface images.

In S611, the camera extrinsic parameter is corrected according to the mutated image and the vector image sequence, and the camera extrinsic parameter corresponding to the mutated image is updated according to the corrected camera extrinsic parameter.

The time-adjacent image corresponding to the mutated image is acquired from the road surface images other than the mutated image. With regard to each mutated image, the camera extrinsic parameter correction method also includes acquiring the standard tangential direction of a road surface feature of the corresponding time-adjacent image; and correcting the camera extrinsic parameter corresponding to the mutated image according to the standard tangential direction so that the to-be-adjusted tangential direction of a corresponding road surface feature of the mutated image is consistent with the standard tangential direction. Then a matching point pair is determined according to the mutated image and the corresponding time-adjacent image, and the camera extrinsic parameter corresponding to the mutated image continues being corrected according to the difference between the two target view angle points in a target view angle point pair.

In an example, kᵢ is selected from a mutated image set to serve as the current to-be-processed frame, and an image frame corresponding to a vector aerial image that overlaps a region of the vector aerial image corresponding to the frame kᵢ is selected from a normal image set formed by road surface images other than the mutated image to serve as the time-adjacent image. This time-adjacent image is added to a time-adjacent image set, for example, set′_{good}={k′₂,k′₂ ∈ n′ᵢ, . . . , n′ⱼ}, corresponding to kᵢ.

At least one time-adjacent image is selected from set′_{good}. With regard to each selected time-adjacent image, a lane line which overlaps the lane line in the vector image corresponding to frame kᵢ is searched for in the vector image corresponding to this time-adjacent image. The standard tangential direction of an overlapping lane line in the vector image corresponding to this time-adjacent image and the to-be-adjusted tangential direction of an overlapping lane line in the vector image corresponding to frame kᵢ are acquired. The camera extrinsic parameter is coarsely corrected such that the to-be-adjusted tangential direction of the lane line in the vector image corresponding to frame kᵢ is consistent with the standard tangential direction of the lane line in the vector image corresponding to this time-adjacent image. With regard to the vector image corresponding to this time-adjacent image and the vector image corresponding to frame kᵢ, camera extrinsic parameter correction is performed with regard to at least one overlapping lane line. After the current correction is completed, correction is continued using the next time-adjacent image.

Feature point extraction and matching are performed on frame kᵢ and each corresponding time-adjacent image by using an optical flow method so that initial matching point pairs are obtained. Stable matching point pairs are extracted using the RANSAC algorithm and added to a matching point pair set, for example, PP={(p_{fm}^{k}^{ᵢ}, p_{fm}^{k′}^{₂})|m ∈ {1, . . . }, kᵢ ∈ set_{bad}, k′₂ ∈ set′_{good}}. p_{fm}^{k}^{ᵢ} denotes a to-be-adjusted pixel point included in frame kᵢ. p_{fm}^{k′}^{₂} denotes a standard pixel point included in the k′₂ frame of time-adjacent image.

In each matching point pair, with regard to a vector image corresponding to the time-adjacent image, a vector coordinate point corresponding to the standard pixel point p_{fm}^{k′}^{₂} is acquired and inversely converted into a point in an aerial image so that a standard target view angle point, for example, p_{b}_{ₘ}^{k}^{ᵢ}, is obtained. p_{b}_{ₘ}^{k}^{ᵢ} denotes a standard pixel point, which corresponds to p_{fm}^{k′}^{₂}, in the aerial image corresponding to frame kᵢ. According to the camera extrinsic parameter H of the mutated image, the to-be-adjusted pixel point p_{fm}^{k}^{ᵢ} is converted into a to-be-adjusted target view angle point, for example, H*p_{fm}^{k}^{ᵢ}, in an aerial image. H*p_{fm}^{k}^{ᵢ} denotes a to-be-adjusted pixel point, which corresponds to p_{fm}^{k}^{ᵢ}, in the aerial image corresponding to frame kᵢ. The matching point pairs are converted into target view angle point pairs, that is, target aerial image capturing point pairs, for example PP_{fb}={(H*p_{fm}^{k}^{ᵢ},p_{b}_{ₘ}^{k}^{ᵢ})|m ∈ {1,2,3, . . . Nₘ}}.

With regard to the target view angle point pair set PP_{fb}, the optimization function

$$Y = min \{ {\sum }_{m = 1}^{{N}_{m}} {( {p}_{{b}_{m}}^{k} - {H}^{*} {p}_{{f}_{m}}^{{k}_{i}} )}^{2} \}$$

is designed. The optimal transformation matrix is acquired using the RANSAC algorithm. In this manner, the camera extrinsic parameter H is updated, and the camera extrinsic parameter corresponding to the mutated image represented by frame kᵢ is corrected.

In this embodiment of the present disclosure, a semantic map is constructed according to the traffic marking feature, feature inference is performed on the mutated position, and inverse projection transformation is performed using the neighborhood feature so that an aerial image is generated. In this manner, the positioning accuracy of elements of the aerial image is greatly improved so that the intuitiveness and accuracy of the road image are improved.

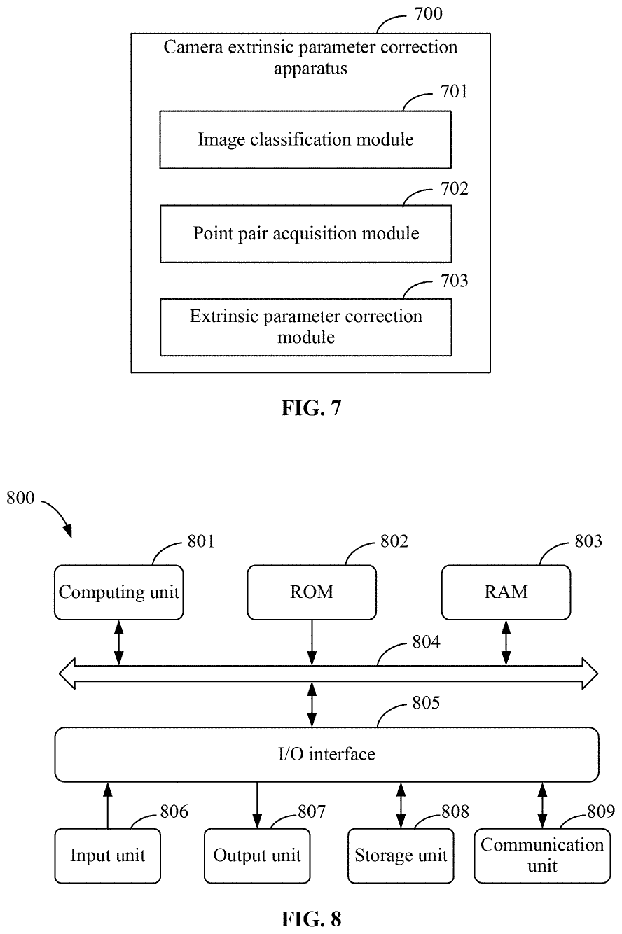

FIG. 7 is a diagram of a camera extrinsic parameter correction apparatus according to an embodiment of the present disclosure. This embodiment of the present disclosure is applicable to the case of correction of a vehicle-mounted-camera extrinsic parameter for conversion between the current view angle and the target view angle. The apparatus is implemented as software and/or hardware and is configured in an electronic device having a certain data operation capability.

As shown in FIG. 7, the camera extrinsic parameter correction apparatus 700 includes an image classification module 701, a point pair acquisition module 702, and an extrinsic parameter correction module 703.

The image classification module 701 is configured to acquire multiple road surface images continuous in time and perform classification to obtain a mutated image and a time-adjacent image corresponding to the mutated image.

The point pair acquisition module 702 is configured to determine a matching point pair from pixel points of the mutated image and pixel points of the corresponding time-adjacent image and determine a target view angle point pair of the matching point pair in a target view angle.

The extrinsic parameter correction module 703 is configured to correct a camera extrinsic parameter corresponding to the mutated image according to the difference between two target view angle points in the target view angle point pair, where the camera extrinsic parameter is configured for conversion of a pixel point in the current view angle into a pixel point in the target view angle.

Further, the point pair acquisition module 702 includes a vector coordinate point acquisition unit configured to acquire a vector coordinate point corresponding to a pixel point of the time-adjacent image in the matching point pair; a standard target view angle point determination unit configured to convert the corresponding vector coordinate point into a standard target view angle point in the target view angle; a to-be-adjusted target view angle point determination unit configured to convert a pixel point of the mutated image in the matching point pair into a to-be-adjusted target view angle point in target view angle according to the camera extrinsic parameter; and a target view angle point pair determination unit configured to determine the standard target view angle point and the to-be-adjusted target view angle point as the target view angle point pair of the matching point pair in the target view angle.

Further, the point pair acquisition module 702 includes a motion consistency analysis unit configured to determine a to-be-adjusted pixel point from the pixel points of the mutated image and a standard pixel point from the pixel points of the corresponding time-adjacent image according to a motion state of the pixel points of the mutated image, a motion state of the pixel points of the corresponding time-adjacent image, and a collection time length between the mutated image and the corresponding time-adjacent image, where the to-be-adjusted pixel point and the standard pixel point correspond to a same vector coordinate point; and a matching point pair acquisition unit configured to determine the to-be-adjusted pixel point and the standard pixel point as the matching point pair.

Further, the camera extrinsic parameter correction apparatus also includes a standard tangential direction acquisition module configured to acquire the standard tangential direction of a road surface feature of the corresponding time-adjacent image; and a camera extrinsic parameter rough adjustment module configured to correct the camera extrinsic parameter according to the standard tangential direction so that the to-be-adjusted tangential direction of a corresponding road surface feature of the mutated image is consistent with the standard tangential direction.

Further, the extrinsic parameter correction module 703 includes a camera extrinsic parameter fine adjustment unit configured to continue correcting the corrected camera extrinsic parameter according to the difference between the two target view angle points in the target view angle point pair.

Further, the image classification module 701 includes a road surface feature recognition unit configured to perform road surface feature recognition on the road surface images; an image classification unit configured to classify the road surface images according to road surface features of the road surface images to obtain the mutated image and normal images; and a similar image query unit configured to determine the time-adjacent image corresponding to the mutated image from the normal images.

Further, the road surface feature recognition unit includes a road surface feature attribute value determination subunit configured to determine target attribute values of the road surface features of the road surface images according to the road surface features; an average attribute value determination subunit configured to determine the average attribute value of the road surface features of the road surface images according to the timing of the road surface images and the target attribute values of the road surface features of the road surface images; and an attribute value classification subunit configured to classify the road surface images according to an identifier attribute threshold and the difference between each of the target attribute values of the road surface features of the road surface images and the average attribute value of the road surface features of the road surface images to obtain the mutated image and the normal images.

Further, the camera extrinsic parameter correction apparatus also includes a target view angle conversion module configured to convert a pixel point of a road surface image into a target view angle point in the target view angle according to an initial camera extrinsic parameter; a positioning module configured to acquire a collection position corresponding to the road surface image; and a vector coordinate acquisition module configured to convert the target view angle point into a vector coordinate point according to the collection position and determine the vector coordinate point as a vector coordinate point corresponding to the pixel point of the road surface image.

Further, the camera extrinsic parameter is of a vehicle-mounted camera.

The camera extrinsic parameter correction apparatus can perform the camera extrinsic parameter correction method according to any embodiment of the present disclosure and has function modules and beneficial effects corresponding to the performed camera extrinsic parameter correction method.

In the solution of the present disclosure, the collection, storage, utilization, processing, transmission, provision, and disclosure of user personal information involved are in compliance with provisions of relevant laws and regulations and do not violate public order and good customs.

According to an embodiment of the present disclosure, the present disclosure also provides an electronic device, a readable storage medium, and a computer program product.

FIG. 8 is a block diagram of an example electronic device for implementing an embodiment of the present disclosure. The electronic device is intended to represent various forms of digital computers, for example, a laptop computer, a desktop computer, a workbench, a personal digital assistant, a server, a blade server, a mainframe computer, or another applicable computer. The electronic device may also represent various forms of mobile apparatuses, for example, a personal digital assistant, a cellphone, a smartphone, a wearable device, or a similar computing apparatus. Herein the shown components, the connections and relationships between these components, and the functions of these components are illustrative and are not intended to limit the implementation of the present disclosure as described and/or claimed herein.

As shown in FIG. 8, the device 800 includes a computing unit 801. The computing unit 801 may perform various appropriate actions and processing according to a computer program stored in a read-only memory (ROM) 802 or a computer program loaded into a random-access memory (RAM) 803 from a storage unit 808. Various programs and data required for the operation of the device 800 may also be stored in the RAM 803. The computing unit 801, the ROM 802, and the RAM 803 are connected to each other through a bus 804. An input/output (I/O) interface 805 is also connected to the bus 804.

Multiple components in the device 800 are connected to the I/O interface 805. The multiple components include an input unit 806 such as a keyboard or a mouse, an output unit 807 such as various types of displays or speakers, the storage unit 808 such as a magnetic disk or an optical disc, and a communication unit 809 such as a network card, a modem, or a wireless communication transceiver. The communication unit 809 allows the device 800 to exchange information/data with other devices over a computer network such as the Internet and/or various telecommunications networks.

The computing unit 801 may be various general-purpose and/or special-purpose processing components having processing and computing capabilities. Examples of the computing unit 801 include, but are not limited to, a central processing unit (CPU), a graphics processing unit (GPU), a special-purpose artificial intelligence (AI) computing chip, a computing unit executing machine learning models and algorithms, a digital signal processor (DSP), and any appropriate processor, controller and microcontroller. The computing unit 801 is configured to perform any preceding method and processing, for example, the camera extrinsic parameter correction method. For example, in some embodiments, the camera extrinsic parameter correction method may be implemented as a computer software program tangibly contained in a machine-readable medium such as the storage unit 808. In some embodiments, part or all of computer programs may be loaded and/or installed on the device 800 via the ROM 802 and/or the communication unit 809. When the computer program is loaded to the RAM 803 and executed by the computing unit 801, one or more steps of the preceding camera extrinsic parameter correction method can be executed. Alternatively, in other embodiments, the computing unit 801 may be configured in any other suitable manner (for example, by use of firmware) to perform the camera extrinsic parameter correction method.

Herein various embodiments of the preceding systems and techniques may be implemented in digital electronic circuitry, integrated circuitry, field-programmable gate arrays (FPGAs), application-specific integrated circuits (ASICs), application-specific standard products (ASSPs), systems on chips (SoCs), complex programmable logic devices (CPLDs), computer hardware, firmware, software, and/or combinations thereof The various embodiments may include implementations in one or more computer programs. The one or more computer programs are executable and/or interpretable on a programmable system including at least one programmable processor. The programmable processor may be a special-purpose or general-purpose programmable processor for receiving data and instructions from a memory system, at least one input apparatus, and at least one output apparatus and transmitting data and instructions to the memory system, the at least one input apparatus, and the at least one output apparatus.

Program codes for implementation of the methods of the present disclosure may be written in one programming language or any combination of multiple programming languages. The program codes may be provided for the processor or controller of a general-purpose computer, a special-purpose computer, or another programmable data processing apparatus to enable functions/operations specified in flowcharts and/or regional diagrams to be implemented when the program codes are executed by the processor or controller. The program codes may be executed entirely on a machine, partly on a machine, as a stand-alone software package, partly on a machine and partly on a remote machine, or entirely on a remote machine or a server.

In the context of the present disclosure, the machine-readable medium may be a tangible medium that may include or store a program that is used by or in conjunction with a system, apparatus or device that executes instructions. The machine-readable medium may be a machine-readable signal medium or a machine-readable storage medium. The machine-readable medium may include, but is not limited to, an electronic, magnetic, optical, electromagnetic, infrared or semiconductor system, apparatus or device or any suitable combination thereof. More examples of the machine-readable storage medium may include an electrical connection based on one or more wires, a portable computer disk, a hard disk, a random-access memory (RAM), a read-only memory (ROM), an erasable programmable read-only memory (EPROM) or a flash memory, an optical fiber, a portable compact disc read-only memory (CD-ROM), an optical storage device, a magnetic storage device, or any suitable combination thereof.

In order that interaction with a user is provided, the systems and techniques described herein may be implemented on a computer. The computer has a display apparatus (for example, a cathode-ray tube (CRT) or a liquid-crystal display (LCD) monitor) for displaying information to the user and a keyboard and a pointing apparatus (for example, a mouse or a trackball) through which the user can provide input to the computer. Other types of apparatuses may also be used for providing interaction with a user. For example, feedback provided for the user may be sensory feedback in any form (for example, visual feedback, auditory feedback or haptic feedback). Moreover, input from the user may be received in any form (including acoustic input, voice input or haptic input).

The systems and techniques described herein may be implemented in a computing system including a back-end component (for example, a data server), a computing system including a middleware component (for example, an application server), a computing system including a front-end component (for example, a client computer having a graphical user interface or a web browser through which a user can interact with implementations of the systems and techniques described herein) or a computing system including any combination of such back-end, middleware or front-end components. Components of a system may be interconnected by any form or medium of digital data communication (for example, a communication network). Examples of the communication network include a local area network (LAN), a wide area network (WAN) and the Internet.

The computing system may include clients and servers. The clients and the servers are usually far away from each other and generally interact through the communication network. The relationship between the client and the server arises by virtue of computer programs running on respective computers and having a client-server relationship to each other. The server may be a cloud server, a server of a distributed system, or a server combined with a blockchain.

It is to be understood that various forms of the preceding flows may be used, with steps reordered, added or removed. For example, the steps described in the present disclosure may be executed in parallel, in sequence or in a different order as long as the desired results of the solutions disclosed in the present disclosure is achieved. The execution sequence of these steps is not limited herein.

The scope of the present disclosure is not limited to the preceding embodiments. It is to be understood by those skilled in the art that various modifications, combinations, subcombinations and substitutions may be made depending on design requirements and other factors. Any modifications, equivalent substitutions, improvements and the like made within the spirit and principle of the present disclosure are within the scope of the present disclosure.

What is claimed is:

1. A camera extrinsic parameter correction method, comprising:
acquiring a plurality of road surface images continuous in time and performing classification to obtain a mutated image and a time-adjacent image corresponding to the mutated image;
determining a matching point pair from pixel points of the mutated image and pixel points of the corresponding time-adjacent image and determining a target view angle point pair of the matching point pair in a target view angle; and
correcting a camera extrinsic parameter corresponding to the mutated image according to a difference between two target view angle points in the target view angle point pair, wherein the camera extrinsic parameter is configured for conversion of a pixel point in a current view angle into a pixel point in the target view angle.

2. The method of claim 1, wherein determining the target view angle point pair of the matching point pair in the target view angle comprises:
acquiring a vector coordinate point corresponding to a pixel point of the time-adjacent image in the matching point pair;
converting the corresponding vector coordinate point into a standard target view angle point in the target view angle;
converting a pixel point of the mutated image in the matching point pair into a to-be-adjusted target view angle point in target view angle according to the camera extrinsic parameter; and
determining the standard target view angle point and the to-be-adjusted target view angle point as the target view angle point pair of the matching point pair in the target view angle.

3. The method of claim 1, wherein determining the matching point pair from the pixel points of the mutated image and the pixel points of the corresponding time-adjacent image comprises:
determining a to-be-adjusted pixel point from the pixel points of the mutated image and a standard pixel point from the pixel points of the corresponding time-adjacent image according to a motion state of the pixel points of the mutated image, a motion state of the pixel points of the corresponding time-adjacent image, and a collection time length between the mutated image and the corresponding time-adjacent image, wherein the to-be-adjusted pixel point and the standard pixel point correspond to a same vector coordinate point; and
determining the to-be-adjusted pixel point and the standard pixel point as the matching point pair.

4. The method of claim 1, further comprising:
acquiring a standard tangential direction of a road surface feature of the corresponding time-adjacent image; and
correcting the camera extrinsic parameter according to the standard tangential direction so that a to-be-adjusted tangential direction of a corresponding road surface feature of the mutated image is consistent with the standard tangential direction.

5. The method of claim 4, wherein correcting the camera extrinsic parameter corresponding to the mutated image according to the difference between the two target view angle points in the target view angle point pair comprises:
continuing correcting the corrected camera extrinsic parameter according to the difference between the two target view angle points in the target view angle point pair.

6. The method of claim 1, wherein performing the classification to obtain the mutated image and the time-adjacent image corresponding to the mutated image comprises:
performing road surface feature recognition on the plurality of road surface images;
classifying the plurality of road surface images according to road surface features of the plurality of road surface images to obtain the mutated image and normal images; and
determining the time-adjacent image corresponding to the mutated image from the normal images.

7. The method of claim 6, wherein classifying the plurality of road surface images according to the road surface features of the plurality of road surface images to obtain the mutated image and the normal images comprises:
determining, according to the road surface features of the plurality of road surface images, target attribute values of the road surface features;
determining an average attribute value of the road surface features of the plurality of road surface images according to a timing of the plurality of road surface images and the target attribute values of the road surface features of the plurality of road surface images; and
classifying the plurality of road surface images according to an identifier attribute threshold and a difference between each of the target attribute values of the road surface features of the plurality of road surface images and the average attribute value of the road surface features of the plurality of road surface images to obtain the mutated image and the normal images.

8. The method of claim 2, further comprising:
converting a pixel point of a road surface image of the plurality of road surface images into a target view angle point in the target view angle according to an initial camera extrinsic parameter;
acquiring a collection position corresponding to the road surface image; and
converting the target view angle point into a vector coordinate point according to the collection position and determining the converted vector coordinate point as a vector coordinate point corresponding to the pixel point of the road surface image.

9. The method of claim 1, wherein the camera extrinsic parameter is of a vehicle-mounted camera.

10. A camera extrinsic parameter correction apparatus, comprising:
at least one processor and
a memory communicatively connected to the at least one processor,
wherein the memory stores instructions executable by the at least one processor to enable the at least one processor to perform the steps in the following modules:
an image classification module configured to acquire a plurality of road surface images continuous in time and perform classification to obtain a mutated image and a time-adjacent image corresponding to the mutated image;
a point pair acquisition module configured to determine a matching point pair from pixel points of the mutated image and pixel points of the corresponding time-adjacent image and determine a target view angle point pair of the matching point pair in a target view angle; and
an extrinsic parameter correction module configured to correct a camera extrinsic parameter corresponding to the mutated image according to a difference between two target view angle points in the target view angle point pair, where the camera extrinsic parameter is configured for conversion of a pixel point in a current view angle into a pixel point in the target view angle.

11. The apparatus of claim 10, wherein the point pair acquisition module comprises:
a vector coordinate point acquisition unit configured to acquire a vector coordinate point corresponding to a pixel point of the time-adjacent image in the matching point pair;
a standard target view angle point determination unit configured to convert the corresponding vector coordinate point into a standard target view angle point in the target view angle;
a to-be-adjusted target view angle point determination unit configured to convert a pixel point of the mutated image in the matching point pair into a to-be-adjusted target view angle point in target view angle according to the camera extrinsic parameter; and
a target view angle point pair determination unit configured to determine the standard target view angle point and the to-be-adjusted target view angle point as the target view angle point pair of the matching point pair in the target view angle.

12. The apparatus of claim 10, wherein the point pair acquisition module comprises:
a motion consistency analysis unit configured to determine a to-be-adjusted pixel point from the pixel points of the mutated image and a standard pixel point from the pixel points of the corresponding time-adjacent image according to a motion state of the pixel points of the mutated image, a motion state of the pixel points of the corresponding time-adjacent image, and a collection time length between the mutated image and the corresponding time-adjacent image, wherein the to-be-adjusted pixel point and the standard pixel point correspond to a same vector coordinate point; and
a matching point pair acquisition unit configured to determine the to-be-adjusted pixel point and the standard pixel point as the matching point pair.

13. The apparatus of claim 10, further comprising:
a standard tangential direction acquisition module configured to acquire a standard tangential direction of a road surface feature of the corresponding time-adjacent image; and
a camera extrinsic parameter rough adjustment module configured to correct the camera extrinsic parameter according to the standard tangential direction so that a to-be-adjusted tangential direction of a corresponding road surface feature of the mutated image is consistent with the standard tangential direction.

14. The apparatus of claim 13, wherein the extrinsic parameter correction module comprises:
a camera extrinsic parameter fine adjustment unit configured to continue correcting the corrected camera extrinsic parameter according to the difference between the two target view angle points in the target view angle point pair.

15. The apparatus of claim 10, wherein the image classification module comprising:
a road surface feature recognition unit configured to perform road surface feature recognition on the plurality of road surface images;
an image classification unit configured to classify the plurality of road surface images according to road surface features of the plurality of road surface images to obtain the mutated image and normal images; and
a similar image query unit configured to determine the time-adjacent image corresponding to the mutated image from the normal images.

16. The apparatus of claim 15, wherein the road surface feature recognition unit comprises:
a road surface feature attribute value determination subunit configured to determine target attribute values of the road surface features of the plurality of road surface images according to the road surface features;
an average attribute value determination subunit configured to determine an average attribute value of the road surface features of the plurality of road surface images according to a timing of the plurality of road surface images and the target attribute values of the road surface features of the plurality of road surface images; and
an attribute value classification subunit configured to classify the plurality of road surface images according to an identifier attribute threshold and a difference between each of the target attribute values of the road surface features of the plurality of road surface images and the average attribute value of the road surface features of the plurality of road surface images to obtain the mutated image and the normal images.

17. The apparatus of claim 11, further comprising:
a target view angle conversion module configured to convert a pixel point of a road surface image of the plurality of road surface images into a target view angle point in the target view angle according to an initial camera extrinsic parameter;
a positioning module configured to acquire a collection position corresponding to the road surface image; and
a vector coordinate acquisition module configured to convert the target view angle point into a vector coordinate point according to the collection position and determine the vector coordinate point as a vector coordinate point corresponding to the pixel point of the road surface image.

18. The apparatus of claim 10, wherein the camera extrinsic parameter is of a vehicle-mounted camera.

19. Anon-transitory computer-readable storage medium storing computer instructions configured to cause a computer to perform the following steps:
acquiring a plurality of road surface images continuous in time and performing classification to obtain a mutated image and a time-adjacent image corresponding to the mutated image;
determining a matching point pair from pixel points of the mutated image and pixel points of the corresponding time-adjacent image and determining a target view angle point pair of the matching point pair in a target view angle; and
correcting a camera extrinsic parameter corresponding to the mutated image according to a difference between two target view angle points in the target view angle point pair, wherein the camera extrinsic parameter is configured for conversion of a pixel point in a current view angle into a pixel point in the target view angle.
